(19) United States
(12) Patent Application Publication
(10) Pub. No.: US 2008/0054779 A1
(43) Pub. Date: Mar. 6, 2008

(54) Surface light source device having secondary electron emission layer, method of manufacturing the same, and backlight unit having the same

(75) Inventors: Kyeong Taek Jung, Suwon-si (KR); Ki Yeon Lee, Suwon-si (KR); Hyung Bin Youn, Suwon-si (KR); Keun Seok Lee, Suwon-si (KR); Dong Hee Lee, Suwon-si (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Samsung Corning Co., Ltd., Suwon-si (KR)

(21) Appl. No.: 11/897,251

(22) Filed: Aug. 29, 2007

(30) Foreign Application Priority Data
Aug. 30, 2006 (KR) 10-2006-0083095
Dec. 27, 2006 (KR) 10-2006-0135271

(51) Int. Cl. H01J 19/06; H01J 9/38

(52) U.S. Cl. 313/311; 445/40

(57) ABSTRACT

There is provided a substrate for a surface light source device, comprising a first secondary electron emission layer including crystalline magnesium oxide (MgO) powder on a surface of the substrate. There is also provided a surface light source device comprising a first substrate and a second substrate facing each other at a predetermined distance between which a discharge space is formed; and an electrode to apply a discharge voltage to the discharge space, wherein a first secondary electron emission layer including crystalline MgO powder is formed on a surface of at least one of the first substrate and the second substrate. Preferably, the crystalline MgO powder is obtained by grinding an MgO sputtering target. There is provided a backlight unit comprising a surface light source device including a discharge space formed between a first substrate and a second substrate, an electrode to apply a discharge voltage to the discharge space, and a first secondary electron emission layer including crystalline MgO powder on a surface of at least one of the first substrate and the second substrate; a case to receive the surface light source device; and an inverter to supply a discharge voltage to the electrode. Preferably, a second secondary electron emission layer ion-exchanged with a secondary electron emitting material is formed under a surface of the substrate.

### CROSS-REFERENCE TO RELATED APPLICATION

This application claims the benefit of Korean Patent Application No. 10-2006-0083095 filed in the Korean Intellectual Property Office on Aug. 30, 2006 and Korean Patent Application No. 10-2006-0135271 filed in the Korean Intellectual Property Office on Dec. 27, 2006, the entire contents of which are incorporated herein by reference.

### BACKGROUND OF THE INVENTION

1. Technical Field

The present invention relates to a surface light source device, a method of manufacturing the same, and a backlight unit having the same, and more particularly, to a surface light source device having a secondary electron emission layer with excellent secondary electron emission capability.

2. Discussion of Related Art

A liquid crystal display (LCD) device displays an image, using an electrical characteristic and an optical characteristic of liquid crystal. Since the LCD device is very small in size and light in weight, compared to a cathode-ray tube (CRT) device, it is widely used for portable computers, communication devices, liquid crystal television (LCTV) receivers, aerospace industry, and the like.

The LCD device includes a liquid crystal controlling part for controlling the liquid crystal, and a backlight source for supplying light to the liquid crystal. The liquid crystal controlling part includes a number of pixel electrodes disposed on a first substrate, a single common electrode disposed on a second substrate, and liquid crystal interposed between the pixel electrodes and the common electrode. The number of pixel electrodes corresponds to resolution, and the single common electrode is placed in opposite to the pixel electrodes. Each pixel electrode is connected to a thin film transistor (TFT) so that each different pixel voltage is applied to the pixel electrode. An equal level of a reference voltage is applied to the common electrode. The pixel electrodes and the common electrode are made of a transparent conductive material.

The light supplied from the backlight source passes through the pixel electrodes, the liquid crystal and the common electrode sequentially. The display quality of an image passing through the liquid crystal significantly depends on luminance and luminance uniformity of the backlight source. Generally, as the luminance and luminance uniformity are high, the display quality is improved.

In a conventional LCD device, the backlight source generally uses a cold cathode fluorescent lamp (CCFL) in a bar shape or a light emitting diode (LED) in a dot shape. The CCFL has high luminance and long life of use and generates a small amount of heat, compared to an incandescent lamp. The LED has high consumption of power but has high luminance. However, in the CCFL or LED, the luminance uniformity is weak. Therefore, to increase the luminance uniformity, the backlight source, which uses the CCFL or LED as a light source, needs optical members, such as a light guide panel (LGP), a diffusion member and a prism sheet. Consequently, the LCD device using the CCFL or LED becomes large in size and heavy in weight due to the optical members.

Therefore, a surface light source device in a flat shape has been suggested as the light source of the LCD device.

Referring to FIG. 1, a conventional surface light source device 100 includes a light source body 110 and an electrode 160 provided on both edges of the light source body 110. The light source body 110 includes a first substrate and a second substrate which are spaced apart from each other at a predetermined distance. A plurality of partitions 140 are arranged between the first and second substrates, and partition a space defined by the first and second substrates. Between the edges of the first and second substrates, sealant (not shown) is interposed to isolate the discharge channels 120 from the exterior. A discharge gas is injected into the discharge spaces 150 in the discharge channels 120.

To drive the surface light source device 100, an electrode is formed on both or any one of the first and second substrates. The electrode has a strip shape or an island shape with the same area per discharge channel. When the surface light source device 100 is driven by an inverter, all channels are uniformly discharged.

However, in the conventional surface light source device, the uniformity of luminance is not good because light emission is different according to the position of the discharge channels. Moreover, a dark region results from channeling by the interference between the adjacent channels.

Specifically, the conventional surface light source device has problems such that environmental pollution is caused by mercury (Hg) which is used as the discharge gas, a stabilizing time of luminance is long at low temperature, and the uniformity of luminance is inferior due to the sensibility of mercury with respect to temperature. There are additional problems to be solved for the big-sized surface light source device.

### SUMMARY OF THE INVENTION

Therefore, the present invention is directed to provide a new surface light source device suitable for a large-sized liquid crystal display device.

Another object of the present invention is to provide a surface light source device and a backlight unit having improved luminance, uniformity of luminance and thin thickness.

Still another object of the present invention is to provide a surface light source device having a low firing voltage and a short luminance stabilization time, to improve light emission efficiency.

The other objects and features of the present invention will be presented in more detail below.

In accordance with an aspect of the present invention, the present invention provides a substrate for a surface light source device, comprising: a first secondary electron emission layer including crystalline magnesium oxide (MgO) powder formed on a surface of the substrate.

The substrate may include a second secondary electron emission layer which is ion-exchanged with a secondary electron emitting material and is formed under a surface of the substrate.

In accordance with another aspect of the present invention, the present invention provides a surface light source device comprising: a first substrate and a second substrate facing each other at a predetermined distance between which an discharge space is formed; and an electrode to apply a discharge voltage to the discharge space, and a first secondary electron emission layer including crystalline magnesium oxide (MgO) powder is formed on a surface of at least one of the first substrate and the second substrate.

The crystalline MgO powder may be obtained by grinding an MgO sputtering target.

At least one of the first substrate and the second substrate may include a second secondary electron emission layer which is ion-exchanged with a secondary electron emitting material under a surface of the substrate.

In accordance with another aspect of the present invention, the present invention provides a backlight unit comprising: a surface light source device including a sealed discharge space between a first substrate and a second substrate, an electrode to apply a discharge voltage to the discharge space, and a first secondary electron emission layer including crystalline magnesium oxide (MgO) powder formed on a surface of at least one of the first substrate and the second substrate; a case to receive the surface light source device; and an inverter to supply a discharge voltage to the electrode.

In the surface light source device and the backlight unit according to the present invention, secondary electrons are easily emitted and thus, the firing voltage is reduced, discharge efficiency is remarkably improved, and heat is reduced during the driving thereof.

The fine structure of the first secondary electron emission layer is powder of the crystalline MgO and in result, the secondary electron emission efficiency is very excellent and durability is high even after long-term use, and the secondary electron emission layer is easily formed and thus, it is advantageous in mass production.

Furthermore, the surface light source device having the first secondary electron emission layer and the second secondary electron emission layer has the advantage that the secondary electron emission is very excellent since the secondary electron emission layers are formed on and under the surface of the substrate.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a perspective view illustrating an example of a conventional surface light source device;

FIG. 2 is a perspective view illustrating a surface light source device according to an embodiment of the present invention;

FIG. 3 is a side view illustrating the surface light source device in FIG. 2;

FIG. 4 is a sectional view illustrating a substrate according to an embodiment of the present invention, on which a first secondary electron emission layer is formed;

FIG. 5 is an enlarged view of a portion “S” in FIG. 4;

FIG. 6 is a diagram comparing secondary electron emission coefficients;

FIG. 7 is a sectional view of a substrate according to another embodiment of the present invention, on which a first secondary electron emission layer and a second secondary electron emission layer are formed;

FIG. 8 is a sectional view of a substrate according to still another embodiment of the present invention, on which a first secondary electron emission layer and a second secondary electron emission layer are formed;

FIG. 9 is a sectional view taken along the line X-X′ in FIG. 2;

FIG. 10 is an enlarged view of a portion “A” in FIG. 9;

FIG. 11 is a sectional view illustrating a multilayer electrode according to still another embodiment of the present invention;

FIGS. 12 through 14 are plan views illustrating various patterns of the electrodes of surface light source devices according to embodiments of the present invention; and

FIG. 15 is an exploded perspective view illustrating a backlight unit including the surface light source device according to the embodiment of the present invention.

### DETAILED DESCRIPTION OF THE INVENTION

The present invention will now be described more fully hereinafter with reference to the accompanying drawings, in which preferred embodiments of the invention are shown.

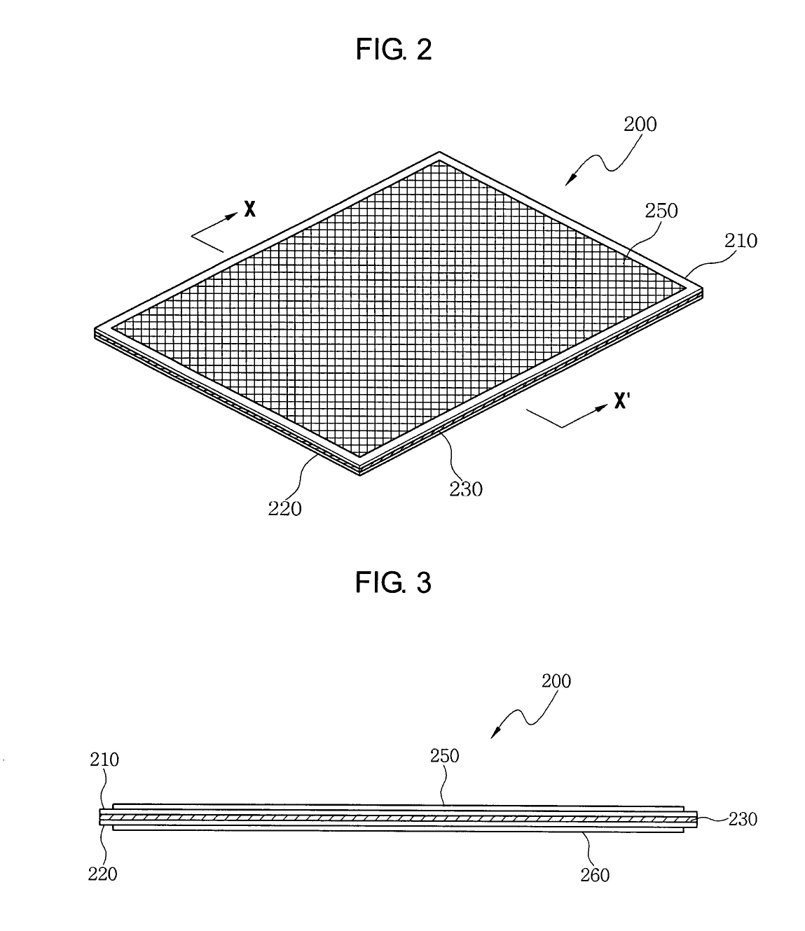

FIG. 2 is a perspective view illustrating a surface light source device 200 according to an embodiment of the present invention, and FIG. 3 is a side view illustrating the surface light source device 200 in FIG. 2.

The surface light source device 200 includes first and second flat substrates 210 and 220 with a same shape. Preferably, the first substrate 210 and the second substrate 220 are transparent thin glass substrates. There is no restriction on the thickness of the first and second substrates 210 and 220, but the first and second substrates 210 and 220 may have a thickness of about 1 mm to 2 mm, preferably 1 mm or less.

Fluorescent layers are coated on the inner surfaces of the first and second substrates 210 and 220, and a reflective layer may be further formed on one of the first and second substrates 210 and 220. The first and second substrates 210 and 220 face each other at a predetermined distance and a sealing member 230 such as frit or a sidewall is inserted between edge of the first and second substrates 210 and 220 to form an isolated space between the first and second substrates 210 and 220.

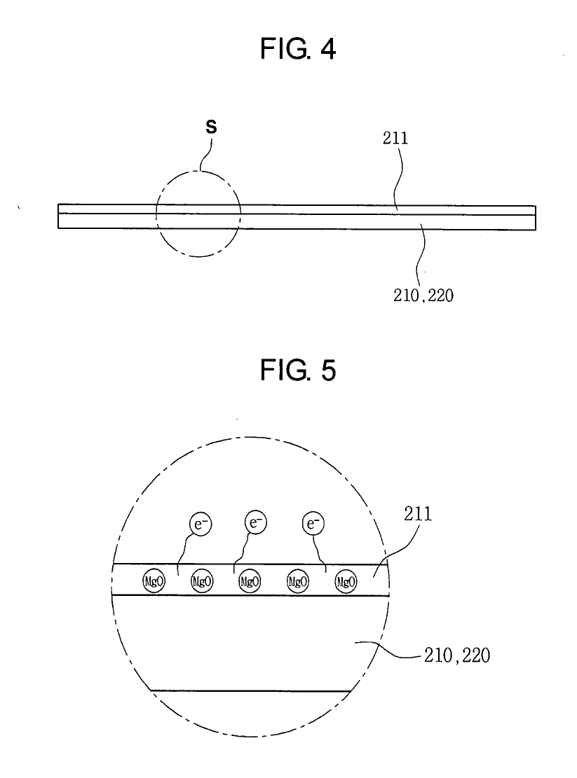

A first secondary electron emission layer 211 is formed, as illustrated in FIGS. 4 and 5, on the surface of the first or second substrate 210 or 220. Preferably, the first secondary electron emission layer 211 is crystalline and has the fine structure of powder rather than a thin film or nano structure. The first secondary electron emission layer of the powder structure has excellent secondary electron emission efficiency.

Preferably, the first secondary electron emission layer of the powder structure may use the powder obtained by grinding a magnesium oxide (MgO) sputtering target. In this case, preferably, particle diameter of the MgO powder in the first secondary electron emission layer may be 1 μm or larger.

The powder obtained by grinding the crystalline MgO sputtering target is mixed with an organic or inorganic solvent. The mixture thereof is coated on the surface of at least one of the first and second substrates, to form the first secondary electron emission layer. If necessary, the first or second substrate coated with the MgO powder may be burned. For example, 560° C. may be selected as a burning temperature.

The first secondary electron emission layer is easily and cost-effectively formed by coating with the MgO powder and is suitable for a large-area surface light source device. During operation of the surface light source device 200, secondary electrons are emitted from the first secondary electron emission layer 211 and thus, the electrical discharge vigorously occurs in the inner space of the substrates. As a result, the firing voltage is reduced and light emission efficiency is improved. Furthermore, heat generated during the operation is reduced and thus, stability of the surface light source device increases.

In the present invention, the secondary electron emission layer need not be formed by a sputtering method or other physical or chemical deposition methods which highly costs but by a coating method, for example, a spray coating method.

Compared to depositing MgO by the sputtering method, coating crystalline MgO powder by the spray coating method in the present invention provides many advantages of high productivity and low cost.

In the sputtering method, there are many demerits in that a high vacuum chamber is required, the size of equipment increases, and yield decreases because it is difficult to continuously carry out processes in a batch mode. MgO is preferably deposited by the sputtering method at a very low speed of one atomic layer/sec, whereas crystalline MgO powder is preferably coated by the spray coating method at a very high speed of 1˜5 μm layer/sec.

In addition, high price single crystalline target is used in the sputtering method, whereas low price single crystalline powder is used in a spray coating method.

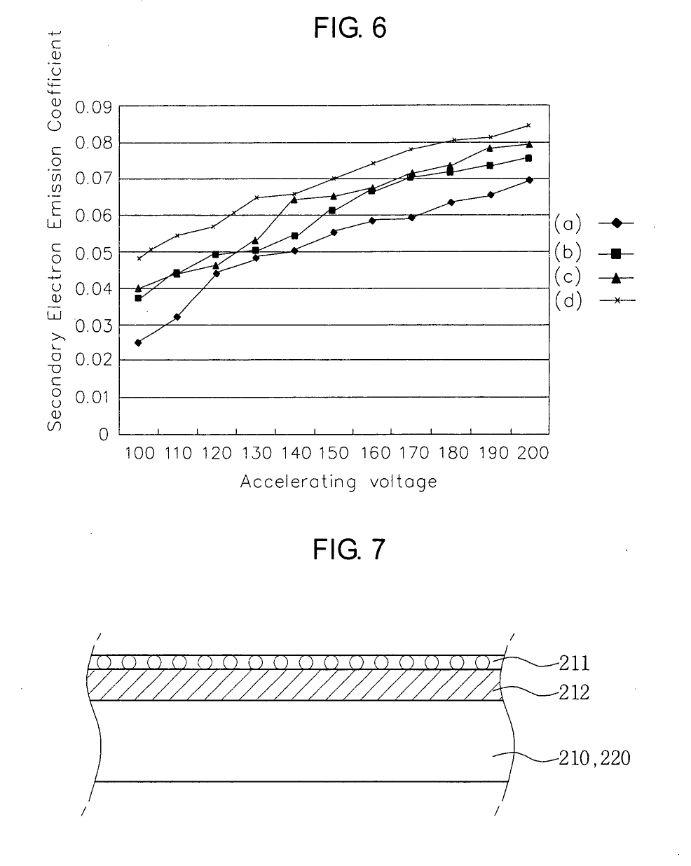

FIG. 6 is a diagram comparing secondary electron emission coefficients.

As shown in the figure, the secondary electron emission coefficients are as follows: (a) without a secondary electron emission layer<(b) with a secondary electron emission layer formed by depositing MgO using the sputtering method<(c) with a secondary emission layer formed by coating poly crystalline MgO powder using the spray coating method<(d) with a secondary emission layer formed by coating single crystalline MgO powder using the spray coating method.

Table 1 as below shows results of a comparison between an e-beam evaporation method, the spray coating method and a printing method.

| | e-beam | | |
|---|---|---|---|
| | evaporation | spray coating | Printing |
| layer thickness | Good | good | good |
| performance | good | very good | good |
| yield/productivity | Bad | good | good |
| cost of equipment | bad | good | good |
| investment | (about a | (about a | (about two |
| | hundred | hundred | hundred |
| | million | thousand | thousand |
| | dollars) | dollars) | dollars) |

Referring to table 1, forming a secondary electron emission layer by coating MgO powder using the spray coating method can provide better performance.

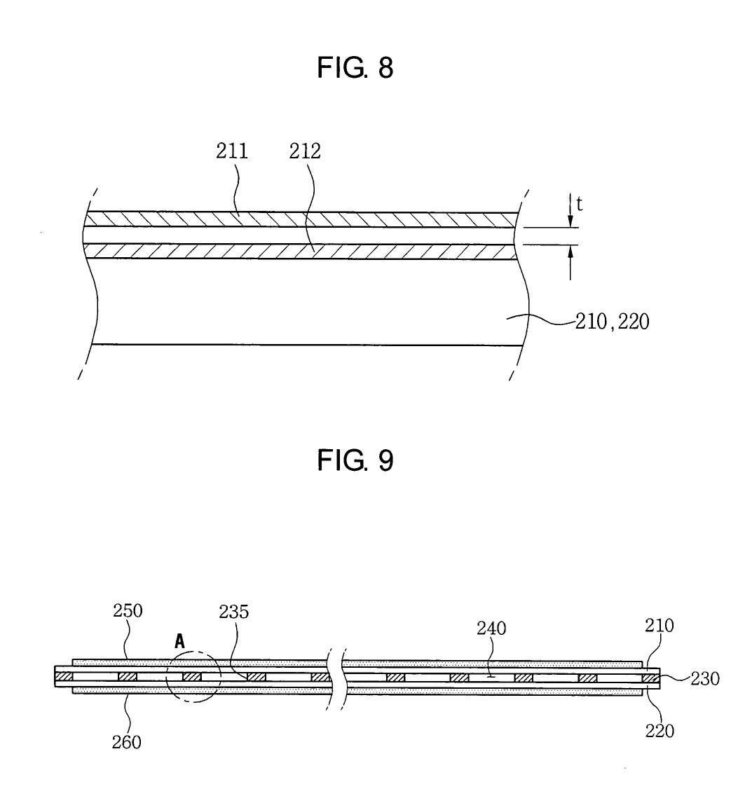

FIGS. 7 and 8 are sectional views of substrates on which first and second secondary electron emission layers 211 and 212 are formed.

The first secondary electron emission layer 211 including crystalline MgO powder is formed on the surface of the substrate, and the second secondary electron emission layer 212 in which an alkali ion (for example, an Na ion) of the substrate are exchanged to another ion (for example, an Mg ion) is formed under the surface of the substrate.

The first secondary electron emission layer may have only a metal oxide or may have an ion and an oxide together.

The second secondary electron emission layer 212 may be formed under the surface of the substrate so as to be adjacent to the first secondary electron emission layer 211 as illustrated in FIG. 7, or it may be formed at a predetermined distance t from the surface of the substrate as illustrated in FIG. 8. The first and second secondary electron emission layers may be spaced apart from each other by a predetermined distance, to improve secondary electron emission capability and durability of the secondary electron emission layers. Preferably, the distance or depth t may be within the range of 3 μm to 10 μm. The ion-exchanged layer may have only an ion or have an ion and an oxide together.

On the substrate for the surface light source device according to the present invention, the secondary electron emission layer may be formed by a coating method rather than an expensive manufacturing process such as a sputtering method or any other physical or chemical vapor deposition methods.

A method of manufacturing the surface light source device will be described. A substrate having a property of transmitting visible light therethrough is prepared. The substrate may be flat or may include a discharge channel in a predetermined shape which is previously formed on the surface thereof. A surface of the substrate is coated with a solution in which a proper solvent is mixed with a material including, for example, magnesium (Mg), i.e., crystalline magnesium oxide (MgO) powder. Subsequently, the substrate is heat-treated. The temperature of the heat treatment may vary according to the structure of the secondary electron emission layer to be formed. The temperature and environment of the heat treatment, pressure, and other processing conditions may be controlled such that a second secondary electron emission layer as an ion-exchanged layer is formed under the surface of the substrate and a first secondary electron emission layer is formed on the surface of the substrate. The second secondary electron emission layer can be formed to have only an ion or have an ion and an oxide together, by controlling the temperature of the heat treatment and others. The first secondary electron emission layer can also be formed to have only a crystalline oxide or have an ion and a crystalline oxide together according to the processing conditions.

After the secondary electron emission layer is formed, additional layers (for example, fluorescent layer, protection layer, reflective layer and so on) may be formed on the surface of the substrate.

The first and second secondary electron emission layers may be simultaneously formed by a single process and it may be formed through separate processes in order to differentiate the constituents of each secondary electron emission layer and to more accurately control the thickness and others. For example, after the second secondary electron emission layer as the ion exchange layer is formed inside the surface of the substrate by using a first material, the first secondary electron emission layer may be subsequently formed on the surface of the substrate by using a second material.

The secondary electron emission layer according to the present invention has excellent durability and more stably exists on the surface of the substrate because the ion-exchanged layer is formed inside the substrate and the surface layer having an oxide is formed on the surface of the substrate. As a result, the secondary electron emission capability is excellent, even after the long-term use of the surface light source device.

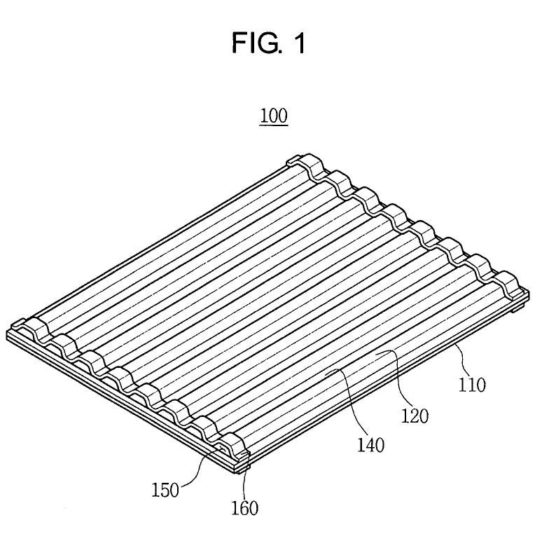

The first secondary electron emission layer according to the present invention is applicable to the surface light source device in which both of the first and second substrates are flat as illustrated in FIG. 2 or either one is a corrugated shape to have a plurality of discharge channels as illustrated in FIG. 1. Furthermore, the first secondary electron emission layer is also applicable to the surface light source device in which independent partitions are formed to partition the discharge space into a plurality of channels.

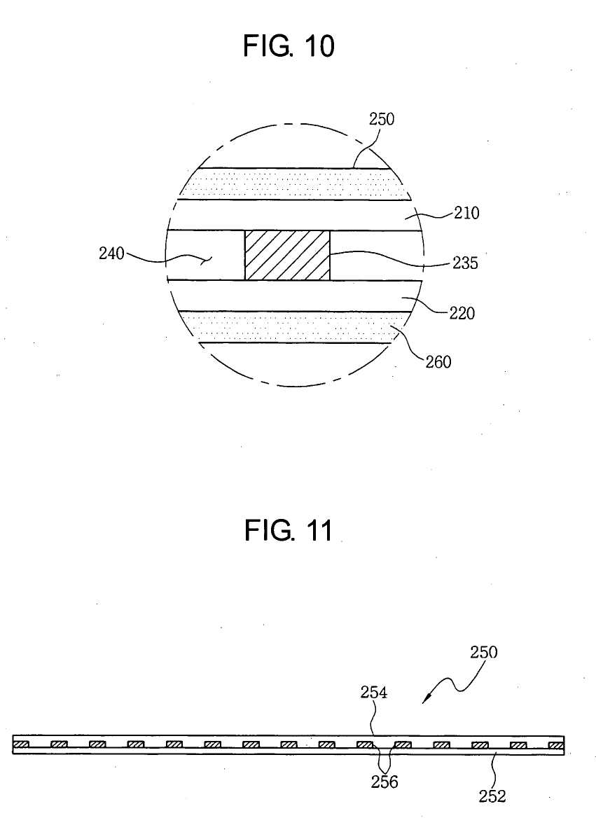

In the surface light source device according to the embodiment of the present invention, a large-area surface electrode is formed on the outer surface of the light source body formed by the first substrate and the second substrate. FIG. 9 is a sectional view taken along the line X-X′ in FIG. 2 and FIG. 10 is an enlarged view of a portion “A” in FIG. 9. As illustrated in FIGS. 9 and 10, a first surface electrode 250 is formed on the outer surface of a first substrate 210, and a second surface electrode 260 is formed on the outer surface of a second substrate 220. The first and second surface electrodes 250 and 260 are formed in the form of a flat surface electrode to substantially cover entire areas of the substrates.

At least one of the first and second surface electrodes 250 and 260 preferably has an aperture ratio 60% or higher, to open the substrates by 60% in order to increase transmittance of light emitted from the light source body.

The first and second substrates 210 and 220 are preferably flat substrates. The inner space defined by the first and second substrates and a sealing member is a single discharge space 240. The distance between the first and second substrates 210 and 220 is narrow relatively small in comparison to the areas of the substrates 210 and 220 and the inner space forms the single space and thus, exhaustion to vacuum and injection of the discharge gas are very easily carried out. Gas such as xenon, argon, neon, and other inactive gas or gas mixture thereof exclusive of mercury is suitable as the discharge gas.

The height of the discharge space 240 formed between the first and second substrates 210 and 220 may be determined by a spacer 235. The number and pitch of the spacers 235 may be determined within a range not to deteriorate the luminance property of the light emitted from the surface light source device. Or, spacers can be obtained by forming one of the substrates. Or, the height of the discharge space 240 may be defined by protruding spacers integrally formed with the inner surface of the first or second substrate 210 or 220.

In the surface light source device according to the embodiment of the present invention, the first surface electrode 250 and the second surface electrode 260 may be transparent electrodes such as indium tin oxide (ITO) or other electrodes with predetermined patterns. FIG. 11 is a sectional view illustrating an electrode employed in an embodiment of the present invention. As illustrated, the electrode has a multilayer structure having a lower base layer 252, an electrode pattern 256 formed on the base layer 252, and a protection layer 254 formed on the base layer 252 and the electrode pattern 256. Preferably, the base layer 252 and the protection layer 254 can transmit visible light therethrough.

In an electrode having only the electrode pattern, it is difficult to bond such an electrode to the glass substrate and durability thereof would be inferior. On the other hand, in the multilayer electrode, the electrode is easily bonded to the substrate, durability of the electrode pattern is guaranteed, and various electrode patterns can be formed.

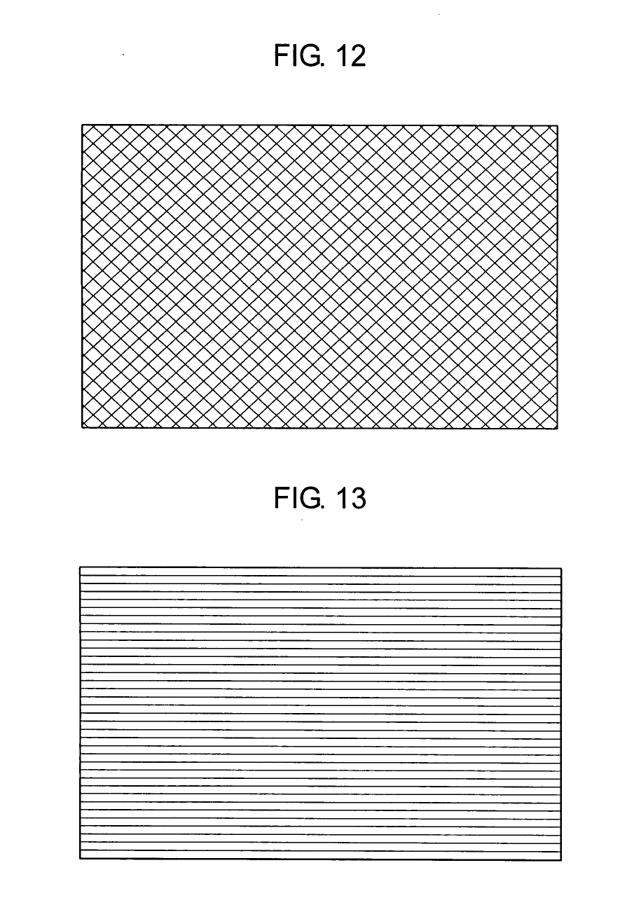

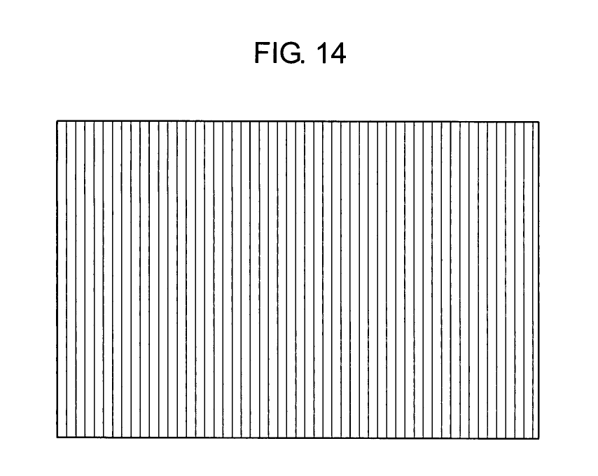

Various patterns may be employed in the flat electrode of the surface light source device according to the embodiment of the present invention. For example, a mesh type pattern as illustrated in FIG. 12, a stripe type pattern as illustrated in FIGS. 13 and 14 may be available. The patterns of the first and second surface electrodes 250 and 260, which are respectively formed on the first and second substrates 210 and 220, may be different from each other, to change the discharge property of the surface light source device.

In the surface light source device in which the electrode is formed on the entire surface of the substrate as illustrated in FIGS. 12 through 14, preferably, the first secondary electron emission layer and/or the second secondary electron emission layer may be also formed on the entire surface of the substrate, to correspond to the electrode.

However, in the surface light source device in which the electrode is formed along the edges of the outer surface of the substrate as illustrated in FIG. 1, preferably, the first secondary electron emission layer and/or the second secondary electron emission layer may be formed along the edges of the inner surface of the substrate, to correspond to the electrode.

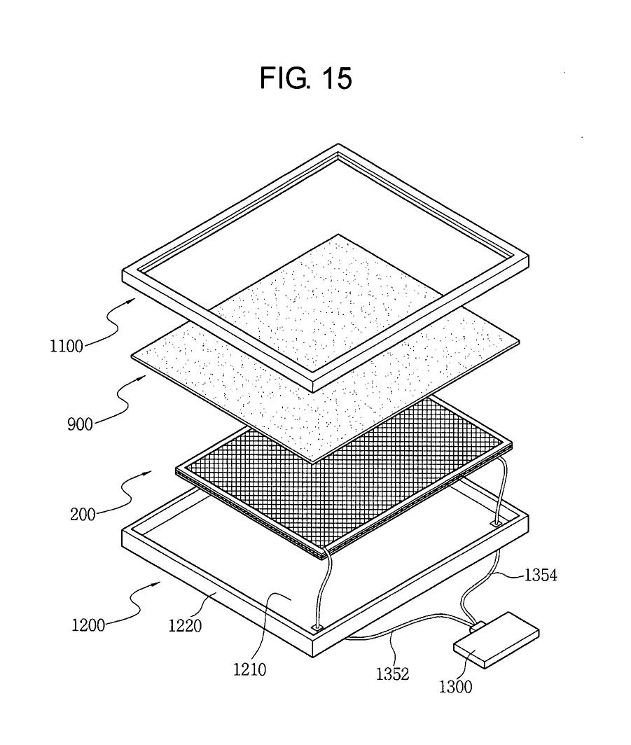

FIG. 15 is an exploded perspective view illustrating a backlight unit including the ultra thin surface light source device according to the embodiment of the present invention. As illustrated, the backlight unit includes a surface light source device 200, upper and lower cases 1100 and 1200, an optical sheet 900, and an inverter 1300. The lower case 1200 includes a bottom 1210 to receive the surface light source device 200 and a plurality of sidewalls 1220 extending from edges of the bottom 1210 to form a receiving space. The surface light source device 200 is received in the receiving space of the lower case 1200.

The inverter 1300 is disposed at the rear side of the lower case 1200 and generates a discharge voltage to drive the surface light source device 200. The discharge voltage generated by the inverter 1300 is supplied to the electrodes of the surface light source device 200 via first and second power lines 1352 and 1354, respectively. The optical sheet 900 may include a diffusion plate to uniformly diffuse light emitted from the surface light source device 200 and a prism sheet to make the diffused light go straight ahead. The upper case 1100 is coupled with the lower case 1200 to settle the surface light source device 200 and the optical sheet 900. The upper case 1100 prevents the surface light source device 200 from being separated from the lower case 1200.

Unlike the drawing as illustrated, the upper case 1100 and the lower case 1200 may be formed in the form of a single integrated case. Meanwhile, the backlight unit may not include the optical sheet 900 because luminance of and luminance uniformity of the surface light source device according to the present invention are excellent.

Since the surface light source device and the backlight unit according to the present invention include the secondary electron emission layer, the secondary electrons are easily emitted, the firing voltage is reduced, the discharge efficiency is remarkably improved, and heat is reduced during the operation thereof. Furthermore, the manufacturing cost of the surface light source device is reduced and the yield of production is high and thus, it is advantageous in mass production.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

1. A substrate for a surface light source device, comprising:
a first secondary electron emission layer including crystalline magnesium oxide (MgO) powder formed on a surface of the substrate.

2. The substrate of claim 1, wherein a second secondary electron emission layer ion-exchanged with a secondary electron emitting material is formed under a surface of the substrate.

3. A surface light source device comprising:
a first substrate and a second substrate facing each other at a predetermined distance between which a discharge space is formed; and
an electrode to apply a discharge voltage to the discharge space,
wherein a first secondary electron emission layer including crystalline magnesium oxide (MgO) powder is formed on a surface of at least one of the first substrate and the second substrate.

4. The surface light source device of claim 3, wherein the crystalline MgO powder is obtained by grinding an MgO sputtering target.

5. The surface light source device of claim 3, wherein particle diameter of the crystalline MgO powder in the first secondary electron emission layer is 1 μm or greater.

6. The surface light source device of claim 3, wherein a second secondary electron emission layer ion-exchanged with a secondary electron emitting material is formed under a surface of at least one of the first substrate and the second substrate.

7. The surface light source device of claim 6, wherein the second secondary electron emission layer is ion-exchanged to include a magnesium (Mg) ion.

8. The surface light source device of claim 6, wherein the second secondary electron emission layer is formed at a distance of 3 μm to 10 μm from the surface of at least one of the first substrate and the second substrate.

9. The surface light source device of claim 6, wherein at least one of the first secondary electron emission layer and the second secondary electron emission layer includes an oxide and an ion together.

10. The surface light source device of claim 3, wherein a single discharge space is formed between the first substrate and the second substrate and a discharge gas exclusive of mercury is provided into the discharge space.

11. The surface light source device of claim 3, wherein the electrode comprises a base layer, an electrode pattern formed on the base layer, and a protection layer formed on the electrode pattern.

12. The surface light source device of claim 3, wherein the first secondary electron emission layer is formed on an entire surface of at least one of the first substrate and the second substrate.

13. The surface light source device of claim 3, wherein one or more partitions are formed to partition the discharge space between the first substrate and the second substrate into a plurality of individual spaces.

14. The surface light source device of claim 3, wherein the electrode is formed along an edge of an outer surface of at least one of the first substrate and the second substrate, and the first secondary electron emission layer is formed along an edge of an inner surface of at least one of the first substrate and the second substrate, correspondingly to the electrode.

15. The surface light source device of claim 3, wherein the crystalline MgO powder is single crystalline MgO powder.

16. The surface light source device of claim 3, wherein the crystalline MgO powder is coated by a spray coating or a printing.

17. A method of manufacturing a surface light source device, comprising:
obtaining crystalline magnesium oxide (MgO) powder by grinding an MgO target;
coating the crystalline MgO powder on a surface of at least one of a first substrate and a second substrate;
bonding together the first substrate and the second substrate to form a discharge space between the first substrate and the second substrate; and
forming an electrode on at least one of the first substrate and the second substrate.

18. The method of claim 17, further comprising:
burning at least one of the first substrate and the second substrate which is coated with the crystalline MgO powder.

19. A backlight unit comprising:
a surface light source device including a first substrate, and a second substrate at least partially spaced from the first substrate; a discharge space formed between the first substrate and the second substrate; an electrode to apply a discharge voltage to the discharge space; and a first secondary electron emission layer including crystalline magnesium oxide (MgO) powder on a surface of at least one of the first substrate and the second substrate;
a case to receive the surface light source device; and
an inverter to supply a discharge voltage to the electrode.

20. The backlight unit of claim 19, wherein a second secondary electron emission layer ion-exchanged with a secondary electron emitting material is formed under a surface of at least one of the first substrate and the second substrate.
